(19) United States
(12) Patent Application Publication
(10) Pub. No.: US 2010/0304931 A1
(43) Pub. Date: Dec. 2, 2010

(54) Motion capture system

(76) Inventor: John F. Stumpf, Phoenix, AZ (US)

Correspondence Address: John F Stumpf, 3140 E. Dry Creek Rd., Phoenix, AZ, 85048, US

(21) Appl. No.: 12/802,016

(22) Filed: May 27, 2010

Related U.S. Application Data
(60) Provisional application No. 61/217,095, filed on May 27, 2009.
(60) Provisional application No. 61/270,234, filed on Jul. 6, 2009.

(51) Int. Cl. A63B 24/00; G08B 5/22

(52) U.S. Cl. 482/4; 340/825.49

(57) ABSTRACT

A motion capture system includes at least four relatively positioned locating units defining an area; an RFID fiducial moving with a movable object within the vicinity of the defined area; the locating units receiving RF signals transmitted by the RFID fiducial; and a processing unit in communication with the locating units and the RFID fiducial, the processing unit transmitting RF signals to the RFID fiducial and receiving information from the locating units in response to the transmitted RF signals and determining a location of the RFID fiducial.

### CROSS-REFERENCE TO RELATED APPLICATIONS

This application claims priority to U.S. provisional application Ser. No. 61/217,095, filed May 27, 2009, entitled MOTION CAPTURE SYSTEM and U.S. provisional application Ser. No. 61/270,234, filed Jun. 6, 2009, entitled MOTION CAPTURE SYSTEM which applications are incorporated herein by reference.

### BACKGROUND

The present disclosure relates to a system for capturing, recording and transmitting motion and/or location data from humans, animals or other objects for use with modeling, computer-generated imagery (“CGI”), interactive gaming, simulation, control of computer systems, and/or to indicate motion of one or more sports players during an event for entertainment, archival or officiating purposes.

Motion capture systems track one or more persons, animals or objects as each moves through 1-dimensional, 2-dimensional or 3-dimensional space. One common application is gait analysis, whereby motion of the joints and limbs of a subject are tracked. Motion capture is also heavily used in the entertainment industry, where live action is integrated with computer-generated effects. Multiple prior art motion tracking technologies exist. Optical, electromechanical and electromagnetic (including radio-frequency “RF”) technologies have each been utilized for motion capture.

Optical motion capture systems often utilize reflective or colored fiducials for point tracking of joints and limbs, or perform analyses on video using anthropomorphic models to extract human motion parameters. Due to opacity of physical objects, optical camera systems suffer from physical “shadowing” whereby a first object/player may be blocked partially or in its entirety by a second object/player. “Shadowing” may also occur where a first portion of a single object/player is obscured by a second portion of the same object/player. This may be for example when an arm obscures part of a chest or head of a player. This often results in failure of motion capture during the “shadowed” events/periods resulting in possible recovery only by complex motion predictive algorithms. For example, multiple player games for home entertainment systems using video motion capture are limited by the spatial positioning of players so as to limit “shadowing.” Additionally, full-frame video processing for motion capture may be computationally and energy expensive thereby limiting functionality, speed and/or portability. These home entertainment systems determine body motion using gesture and/or posture recognition. These systems often do not permit high resolution determination of location and motion parameters. High resolution camera systems also often require special expensive suits, expensive optical systems and/or professionals to run them in a specifically designed studio for optimal performance. These systems may not be suitable for temporary or consumer-based applications of motion capture.

Electromechanical systems and suits generally utilize electromechanical devices such as potentiometers and strain sensors to capture movements of limited numbers of locations in space such as rotations of joints. Electromechanical sensors may be wired or wirelessly connected to centralized processing capabilities. An example of electromechanical systems is described in U.S. Pat. No. 6,070,269 entitled “Data-Suit for Real-Time Computer Animation and Virtual Reality Applications.”

Electromagnetic trackers generally work on the principle that an electromagnetic fiducial creates an electromagnetic field, or modifies an electromagnetic field which has been transmitted near it. U.S. Pat. No. 5,513,854 describes a system in which each player on a field carries a miniaturized RF transmitter. RF goniometric receivers determine the direction of the transmitted signals, and triangulation methods are used to determine the position of the transmitters. Although other motion capture systems may also utilize the Global Position System (“GPS”) to track the positions of objects, these solutions are often relatively slow, inaccurate (˜3 meter positional accuracy) and expensive.

### SUMMARY

In an embodiment, a motion capture system includes at least four relatively positioned locating units defining an area; an RFID fiducial moving with a movable object within the vicinity of the defined area; the locating units receiving RF signals transmitted by the RFID fiducial; and a processing unit in communication with the locating units and the RFID fiducial, the processing unit transmitting RF signals to the RFID fiducial and receiving information from the locating units in response to the transmitted RF signals and determining a location of the RFID fiducial.

In an embodiment, an article for use with a motion capture system includes an RFID fiducial and an article code; the article code identifying the article and an individual cell code for the RFID fiducial.

In an embodiment, a treadmill for use with a motion control system includes an upper platform connected with at least two rollers; at least one of the rollers driven by a motor; the rollers supporting and driving a belt; a gimbal assembly connecting the upper platform with a lower platform; the belt and the gimbal assembly responsive to the motion control system whereby modifying at least one of roll, pitch, yaw and belt speed.

### BRIEF DESCRIPTION OF DRAWINGS

The present disclosure may be understood by reference to the following detailed description taken in conjunction with the drawings briefly described below. It is noted that, for purposes of illustrative clarity, certain elements in the drawings may not be drawn to scale.

FIG. 1 is a schematic diagram of a motion capture system including a tracked human subject, in accordance with an embodiment.

FIG. 2 is a plan view of a portion of transducer matrix film used with a motion capture system, in accordance with an embodiment.

FIG. 3 is a three-dimensional view of a motion capture system incorporated with a playing field including a plurality of tracked human subjects, in accordance with an embodiment.

FIG. 4 is a three-dimensional view of a localized motion capture system including a tracked human subject, in accordance with an embodiment.

FIG. 5 is a three-dimensional view of an article fabricated from transducer matrix film for use with a motion capture subsystem, in accordance with an embodiment.

FIG. 6 is a three-dimensional view of a treadmill which may be used with a motion capture system, in accordance with an embodiment.

FIG. 7 is an additional three-dimensional view of the treadmill of FIG. 6 showing further details.

### DETAILED DESCRIPTION OF ILLUSTRATED EMBODIMENTS

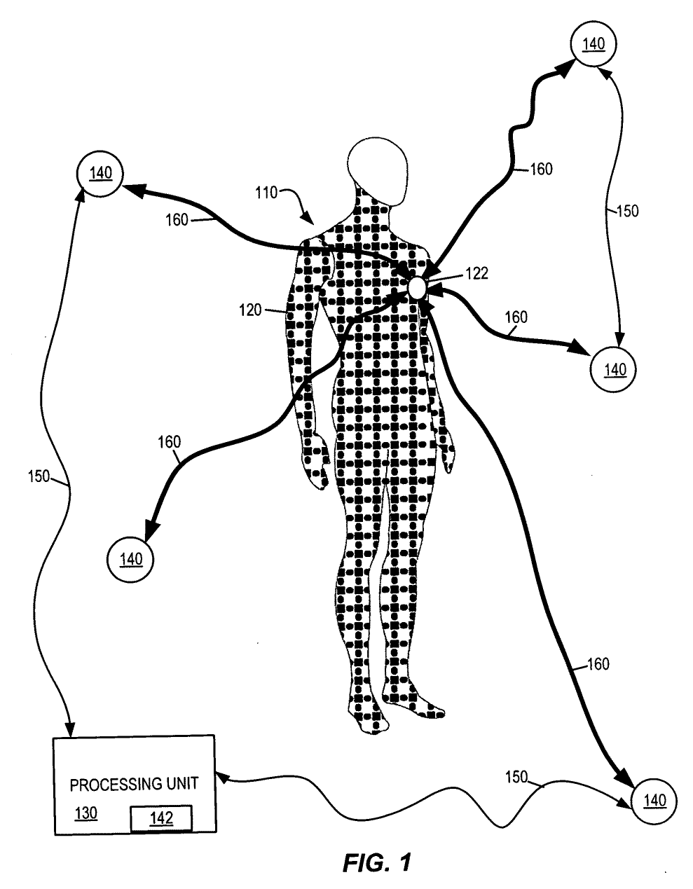

FIG. 1 shows a scene of human subject 110 wearing suit 120 of transducer matrix film as part of a motion capture system. Transducer matrix film (“TMF”) is described in detail in published U.S. Patent Application 20090272206, entitled “TRANSDUCER MATRIX FILM” and incorporated herein by reference. As described therein, TMF includes a plurality of transducer elements formed on a flexible substrate with localized circuit elements and interconnects associated with each transducer element which may transduce a stimulus such as stress, pressure, shear, strain, light, heat, electromagnetic energy, RF radiation and temperature. Although shown wearing entire suit 120 of TMF, human subject 110, such as a participant in soccer, American football, basketball, hockey baseball, golf, track and field, gymnastics, ice skating, etc. may wear other articles such as a jersey, helmet, footwear, glove or shin-guards which incorporate TMF and are appropriate for capturing or monitoring desired motion and/or location parameters such as for feet and/or hands of soccer players. Human subject 110 may also be a participant in an online game, or a user of a home entertainment system or other interactive device such as a personal computer any of which may benefit from interactive control provided by motion capture. Human subject 110 may also use suit 120 or another article, which is part of a motion control system, to interact with a personal computer or any other electronic device. Motion and location parameters may be defined herein as data denoting the absolute or relative position and/or motion of at least a portion of any person, animal or object tracked by a motion capture system. As described herein below, the position and/or motion of a tracked person, animal or object is aided by the use of one or more RFID fiducials associated with the tracked person, animal or object which may be disposed within a TMF device.

A motion capture system includes processing unit 130 and a plurality of radio-frequency transmitter/receiver locating units (“LU”) 140. Although in FIG. 1, 5 LU 140 are shown, more LU may be employed to increase location precision, decrease error or provide fault tolerance. For example, an additional LU 142 may be incorporated or co-located with processing unit 130 so that only 4 LU 140 may be used physically independent. Additionally or optionally, processing unit 130 may be stand-alone or integrated with a audio/visual system such as a home entertainment/game system, speaker system or other controller.

Any of the plurality of LUs 140,142 may be in continuous or periodic communication with processing unit 130 via RF signals 150 or other means either wired (not shown) or wireless. Wired communication systems may include Ethernet, USB and the like. The plurality of LUs 140,142 may each determine their relative positions in 3D space using trilateration methods and calculations utilized by global positioning systems (“GPS”) or multilateration. An example of trilateration methods and calculations is described in U.S. Pat. No. 7,009,561, entitled “Radio frequency motion tracking system and method” which is hereby incorporated by reference. One or more LU 140,142 may also communicate with one or more other LU 140,142 using RF signals, other wireless systems or wired communication. Detailed descriptions of wireless communication methods and signal encoding among LU 140,142 and/or between LU 140,142 and processing unit 130 are well known in the art and several methods are described in U.S. Pat. No. 7,009,561 and the references therein. LUs 140,142 may communicate with processing unit 130 or each other via RF signals 150 for the purposes of relaying data and other signals for motion capture system setup and calibration and for position/motion parameters for human subject 110 by use of signals emitted from one or more RFID fiducials disposed within a portion 122 of TMF suit 120 worn by human subject 110. For clarity, not all possible RF signals are shown.

Time synchronization of LUs 140,142 is important for operation since position determination is based upon the relative timing of receipt of signals to each LU 140,142. Each LU 140,142 may be synchronized by hard-wiring together with known cable lengths or known transit times. Transit times for each LU 140,142 may then be determined/calibrated and maintained constant. A pulse/echo type signal relayed between processing unit 130 and LUs 140,142 may actively monitor/maintain the calibration. Alternatively, each LU 140,142 may include a temperature-stabilized crystal oscillator such as a MEMS oscillator. LUs 140,142 may be periodically engaged with docking features of processing unit 130 for calibration. During a calibration sequence, any drift of a clock within an LU 140,142 may be determined and using data from previous calibration sequences, drift rate may be estimated and algorithmically corrected. Other methods of calibration may include radio broadcast timing signals (WWV, WWVB) and Network Time Protocol (“NTP”) methods.

Subsequent to deployment of LUs 140,142, locations and distances between LUs 140, 142 may be determined via well known location determination methods such as trilateration, multilateration and triangulation. Herein, location determination may be described with respect to a specific location determination method, but it should be understood that methods other than the one specifically noted may be optionally or alternatively applied to the location determining process. Since 5 or more LUs 140,142 are used and the transmit time may be determined for each LU 140,142; each may be trilaterated with the other LUs 140,142. If the calibration and determination of distance/transit delay between each LU 140,142 and processing unit 130 is performed shortly after LUs 140,142 are synchronized, then differential drift of timing between LUs 140,142 may be minimized. With fixed positioning or hard-wiring of LUs 140,142 drift over time (hours, days, etc.) may be determined since original delays between LU 140,142 and processing unit 130 is/was known. If an LU 140,142 is repositioned or has power interruptions (e.g., dead battery) then that LU 140,142 may be returned to processing unit 130 for recalibration.

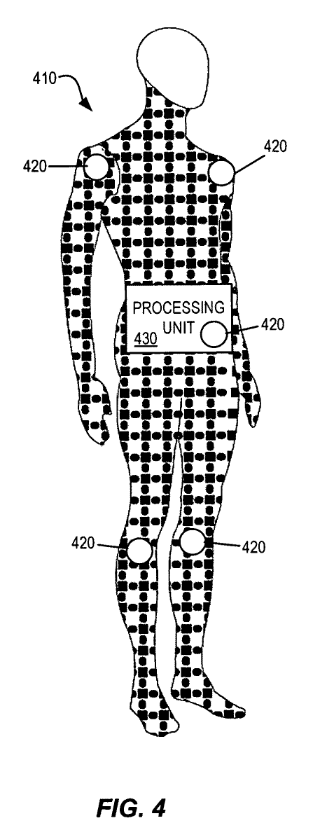

LUs 140,142 may be mounted with brackets or other fixturing devices that permit repeated engagement/disengagement of an LU 140,142; so that an LU 140,142 may be periodically or as necessary returned to processing unit 130 for actions such as battery recharging and clock resynchronization. Periodic performance of these types of actions may better enable wireless operation of the system. The abovementioned synchronization options may be applied to motion capture systems incorporating LUs 140, 142 either worn on a participant (as described below in association with FIG. 4) or placed within an area of interest.

A portion 122 of TMF suit 120 worn by human subject 110 may include one or more RFID fiducials such as used for radio frequency identification (“RFID”) systems and may emit or sense RF signals 160 for communications between suit 120 and any LU 140,142 for determination of position information. RFID fiducials may be energized by emission of RF signals 160 from LU 140,142 or from other RF signals from processing unit 130 (not shown).

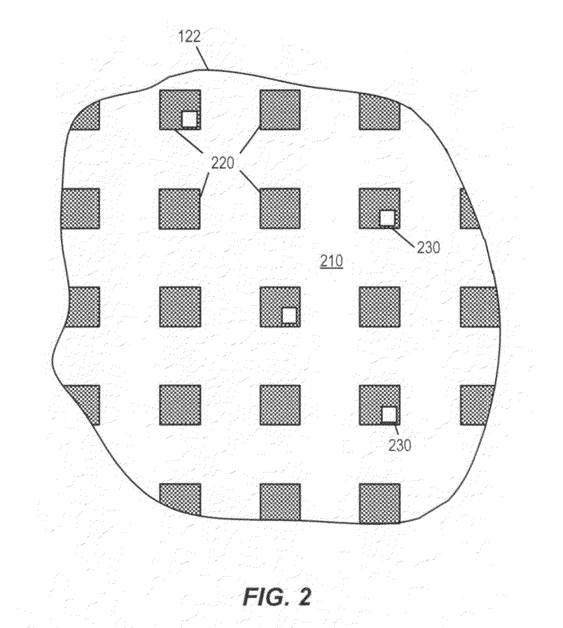

FIG. 2 shows an enlarged view of portion 122 of TMF suit 120 worn by human subject 110 in FIG. 1 as part of a motion capture system. Portion 122 of TMF includes a non-conductive substrate 210 and no signals may be required to be transferred between cells 220 of the TMF (not all cells are labeled). Substrate 210 may be formed from elastane or other pliable material which will conform to a portion of the body of human subject 110. Any or all cells 220 may each include one or more RFID fiducials 230 and/or other devices, electronics, sensors, receivers/transmitters which are either deformable with flexible substrate 210 or may be rigid and applied to a portion of substrate 210 which does not require flexibility of cells 220 or RFID fiducials 230. Each RFID fiducial 230 may communicate with any of LU 140,142 for determining location of a specific cell(s) 220 associated with each RFID fiducial 230.

An exemplary motion capture system operates by providing an RF signal, such as RF signals 160 of FIG. 1, which is external to any cell 220 and additionally external to human subject 110 and TMF suit 120. The RF signal may originate from any of LU 140,142 or processing unit 130 shown in FIG. 1. The RF signal excites an RFID fiducial 230 embedded in cell 220 and energizes a capacitor or other energy storage device for that cell 220. Cell 220, having received power from the external source, is then able to transmit a responsive RF signal as a reply. Each cell 220 within the TMF suit 120 retains a cell identification code and when it receives a matching cell identification code from an external device such an LU 140,142 or processing unit 130 shown in FIG. 1, it will emit a responsive RF signal. This responsive RF signal may then be used to determine the position of the transmitting cell. In this way individual cells 220 may be addressed and located by a motion capture system. An RF signal used for transmitting a cell identification code may be the same or different from an RF signal used to energize any of cells 220. Additionally or optionally, battery power, solar power, storage capacitors, piezoelectrics or other power generation devices such as the nanogenerator discussed in the article “Improved Nanogenerators Power Sensors Based on Nanowires” developed by the Georgia Institute of Technology may energize cells 220.

Unless RF beaming forming and spatial beam sweeping is utilized, for location determination RF signals for cell charging and locating must cover a volume at least as large as the physical space of the cells to be located. Since a motion capture system will have multiple cells 220 including RFID fiducials 230 and each cell 220 only sends a responsive locating signal when it receives its specific cell identification code, each cell 220 may receive multiple charging pulses for each RF transmission from an LU 140,142 or processing unit 130 each time a location is queried. Thus the pickup coil size of RFID fiducials 230 may be reduced for each cell 220 and the power of responsive emission may be higher. For example, if there are 100 cells 220 used with a motion control system and the cell codes are sequentially transmitted with charging pulses any individual cell 220 will receive 100 charging pulses for each location determination query for all 100 cells 220. Thus the emission from any individual cell 220 may be at a much higher power level than what is common with individualized RFID devices each responding to every pulse. Furthermore, the higher the cell count the smaller the pickup coil size of RFID fiducials 230 may be. For example, for a motion capture system with 1000 cells vs. 100 cells, the pickup coil may be 1/10 of the size since the average cell will receive 10× of the charging pulses. This assumes uniform sequential scanning of the cells.

This responsive RF signal may be received by any or all of LU 140,142, each one at a respective time. Since the time of origination of the signal sent by cell 220 is not known or may not be determined with sufficient accuracy by the rest of the motion capture system; only differences in arrival time for the signal at each LU 140,142 may be determined. Since common GPS trilateration requires four independent devices with the transmit time known, additional LUs, such as shown in FIG. 1 aid in trilateration when only the differences in receive times of the responsive RF signal are known.

Current designs of RFID tags either from silicon, metal or flexible polymer may be used or customized to include new signals, frequencies and/or waveforms for specific application requirements. For example, in a motion capture system with multiple participants, certain cells 220 may be tracked together (have the same function) or may be tracked independently (have dissimilar functions or require independence).

Simplifying the TMF material to an array of non-interconnected, externally powered cells 220 with RFID fiducials minimizes cost and complexity of the motion capture system. An additional advantage of the system is that there is no requirement for batteries, wires or other power sources to be included with the system for inclusion on human subject 110. Furthermore, cells 220 as incorporated into TFM suit 120 are light weight and thus do not impair movement. Optionally to incorporation into TFM, cells 220 may be printed upon a substrate with a pressure sensitive adhesive, and cells 220 may be selectively positioned and adhered in a permanent or temporary way to clothing or other articles worn by or optionally adhered to the skin of human subject 110. In light of this manufacturing simplicity, cells 220 may be produced very inexpensively and therefore be fully disposable. Sensory data such as stress, pressure, shear, strain, light, heat, electromagnetic energy, RF radiation and temperature monitored by the TMF may also be conveyed over RF signals transmitted by RFID fiducials.

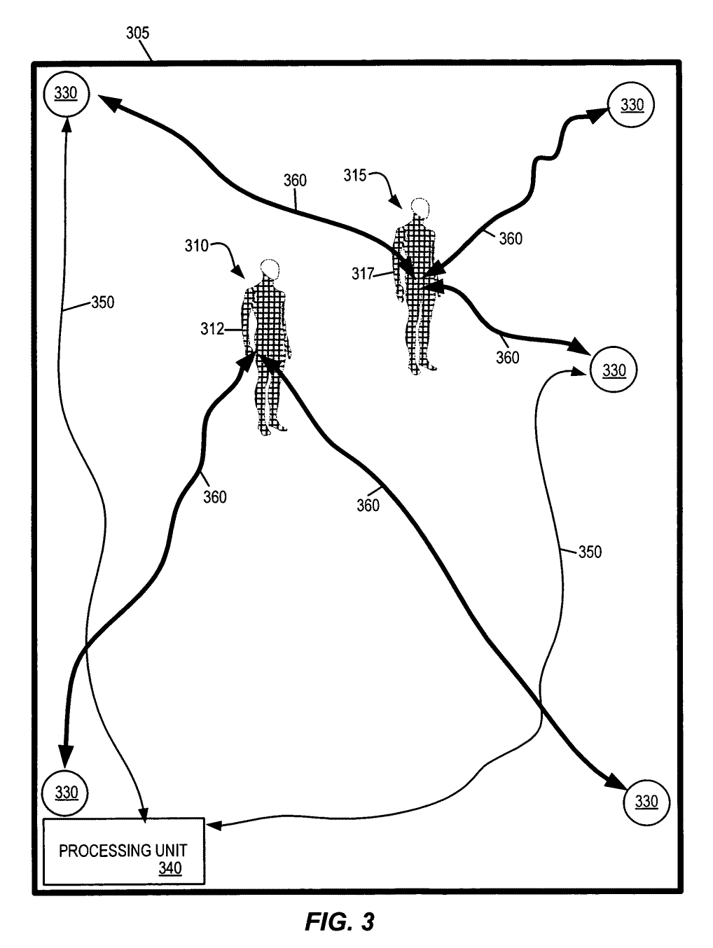

A motion capture system may be used in single or multiple participant sports like football or basketball, such as listed herein, as well may be included as a part of a home entertainment system with a video display such as Sony PlayStation or Nintendo Wii, etc. FIG. 3 shows a three-dimensional view of a motion capture system incorporated with a playing field or room 305 including a plurality of tracked human subjects 310 and 315. Human subjects 310, 315 applies TMF cells, such as cells 220 of FIG. 2, by either adhesive application or by wearing an articles such as a TMF bodysuit 312 or 317, glove, jersey, etc.

Five or more LUs 330 may be placed around room 305. LUs 330 may be wired or wirelessly connected to processing unit 340 which may be incorporated into or located with an entertainment system. Power to LUs 330 may be provided by Power over Ethernet, batteries or wall plug. LUs 330 may communicate with processing unit 340 by RF signals 350. One or more TMF cells with RFID fiducials, such as cells 220 of FIG. 2, of bodysuit 312, 317 may be interrogated and the locations of each cell may be trilaterated by data received by each LU 330 and processed by processing unit 340. Data output from the trilateration may then be streamed to a real-time display (not shown) for presentation of human subject body motion and location or stored for later use. It should be noted that not all RF connections are shown.

Additional benefit may be provided by defining one or more fixed points in space for calibration of the motion capture system. This may provide absolute positioning calibration with respect to a controller or other object for setting a specific point-of-view or perspective. Calibration may be performed, for example, by requiring a user to position his/her body in a certain way and contacting, for example, processing unit 340 with a portion of his/her body (e.g., an index finger or foot) requiring motion capture which is associated with at least one cell with an RFID fiducial. This calibration places at least one RFID fiducial proximate to a known physical reference point.

Processing routines with a motion capture system may prompt a user to perform a series of calibration actions to determine/fix distances between LUs and/or a processing unit or display. LUs may be temporarily placed, permanently installed or integrated with an audio/visual system, such as speakers for a home theatre system. Optionally, an LU may be built into a speaker and hard wire “permanently” installed. LUs may be battery powered or may incorporate systems for utilizing wall power. Further routines may prompt instructions for set-up and positioning of each LU within the space to be monitored.

Location and motion data collected by a motion capture system may be stored for later playback or modification at any time. For example, a professional athlete may be recorded by a herein described motion capture system for later use in a video sports game or simulation. Additionally, a musician may be recorded for inclusion in an interactive game like Guitar Hero. Location and motion data may also be transmitted via the Internet for interacting with a virtual or augmented reality world with other participants anywhere in the real world. For example, captured motion in the real world may be transferred to avatars in the virtual world that would move as the participant moved. This type of motion transfer may be useful for fighting games such as Halo where instead of finger motion on a controller, actual body motion controls the avatar. Unlike using video motion detection, actual image details are not transferred thereby ensuring anonymity for a participant.

As shown in FIG. 4, human subject 410 may support and be mobile with a motion capture system directly upon their person whereby generating local motion data for that individual or portions of their body. LUs 420 may be placed at suitable locations with regard to the body such as arms, legs, shoulder and/or waist where sufficient physical separation is provided for LUs 420 to receive unambiguous trilateration data. Processing unit 430 may then include a GPS system and transmitter for determining an absolute/relative position of participant 410 with respect to the room or field of play and transmitting the local position/motion signals to a higher level system that is tracking all participants. Processing unit 430 may also be used with an associated RFID fiducial and a motion capture system such as described in association with FIG. 2 to provide “global” location and motion information for human subject 410. Processing unit 430 may be battery powered and may transmit/receive signals from the higher level system via RF or other communication methods. Since LUs 420 are moving with respect to a fixed reference points, such as a floor or building, they may also be tracked/located continuously to reference relative motions between each of LUs 420, processing unit 430 and one or more external reference points.

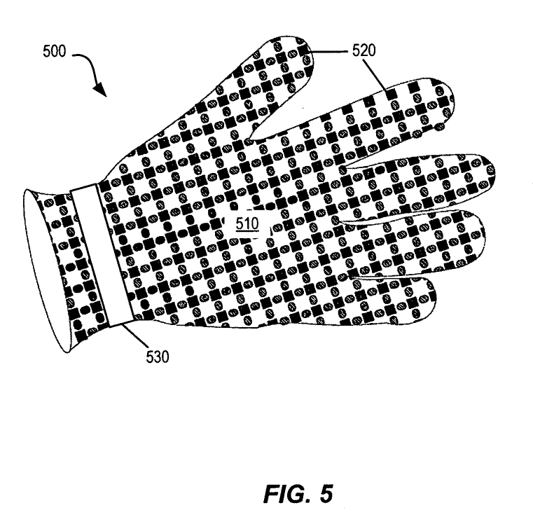

A motion control system may include a localized portion of TMF, such as glove 500 as shown in FIG. 5, which may permit tracking of individual fingers or other hand motions. Glove 500 may be formed of TMF 510 with individual cells 520 each including an RFID fiducial. Glove 500 may also include LU 530 which communicates via wire or wirelessly with cells 520 of TMF 510. Additionally, LU 530 may communicate with a processing unit such as shown in FIGS. 1 and/or 4. Other body parts and/or objects may be similarly instrumented with suitably formed portions of TMF.

An article formed from TMF (suit, glove, shirt sheet of cells etc.) may include an RFID tag, barcode or other identifying means providing an article code identifying the article and any individual cells codes for included RFID fiducials. An article code may be read by a motion capture system processing unit (or entered manually). This code may be used to identify what range of individual TMF cell codes are in the cells within the article. A motion control system may store this cell identification data from the factory and use an algorithm to determine or look up via the Internet related information to determine the cell code range to be used and the information regarding the use of the article such as physical orientation of the article during use, anthropomorphic modeling of the article and cell code relations for example for defining a hand in a glove article with identification of cell codes for the fingers, palm and wrist. In this way, TMF articles for use with a motion control system may be purchased/provided separately and the factory installed TMF cell codes may be easily known and used by a motion capture system. An article may be used by a user to control an interactive device or system such as described herein. RF signals from RFID fiducials within an article formed from TMF may encode sensory data as well as location information.

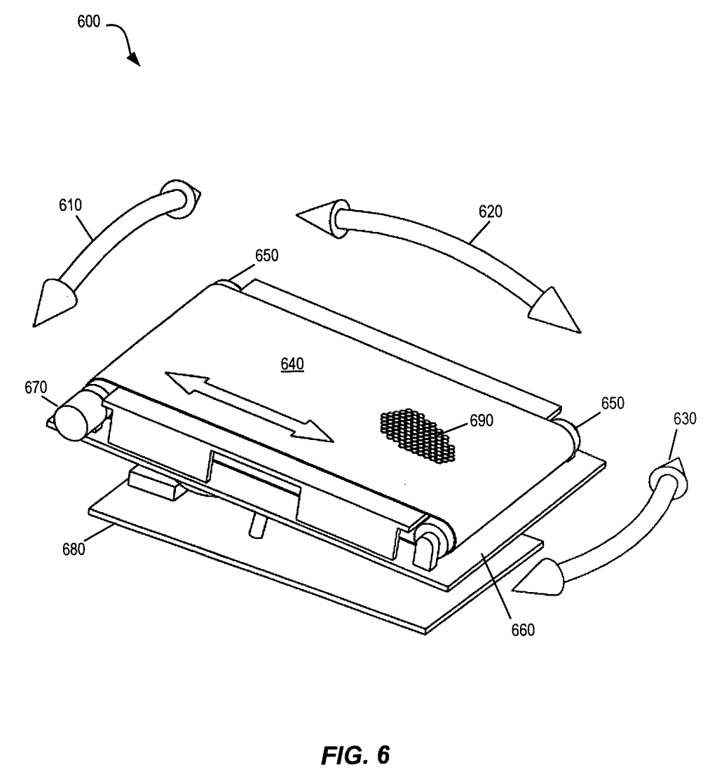

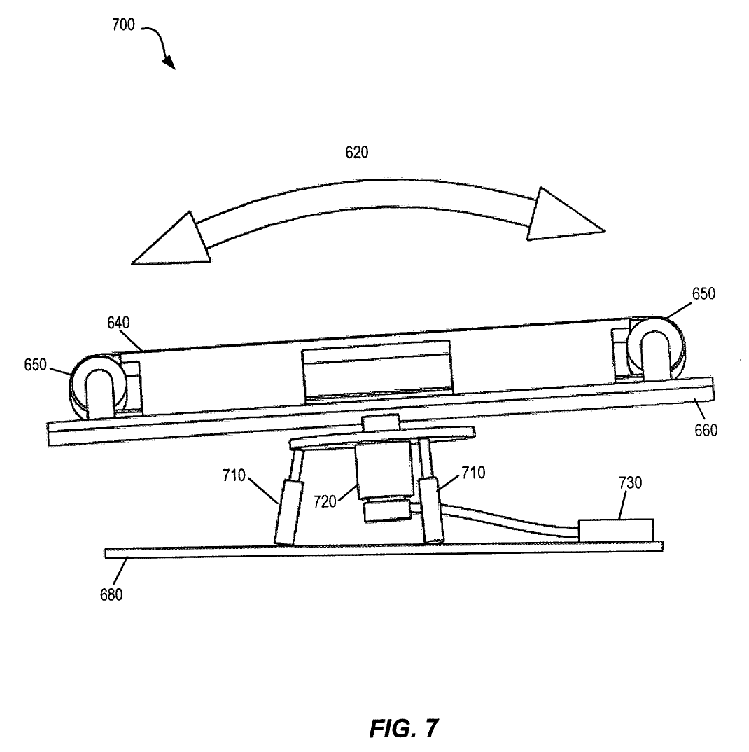

FIGS. 6 and 7 show three-dimensional views of treadmill 600 which may be used with motion capture systems described herein. Treadmill 600 removes limitations associated with stationary motion capture systems used on a floor which only allow short distance motion (e.g., one must run in place). Furthermore, treadmill 600 removes limitations associated with conventional treadmills which provided motion in a single linear direction and operate at a set speed/tilt or change speed/tilt based only upon pre-programmed settings. Motion capture systems such as described herein may provide feedback to actively change speed, tilt and direction in real-time for a modified treadmill. Feedback to treadmill 600 may be provided, for example, by gait monitoring, footfall monitoring and/or other body position/motion parameters. Therefore, as a user moves, treadmill 600 may reposition roll 610, pitch 620 and yaw 630 axes or changes speed of belt 640 to continuously keep the user on belt 640. Although 4 degrees-of-freedom (“DOF”) (roll, pitch, yaw and belt speed) are described as modifiable/controllable, it should be noted that fewer or more DOF may be modifiable/controllable in any combination. For example, motion in a full Cartesian coordinate system may be defined using 6 DOF, namely 3 translations in orthogonal XYZ axes and 3 rotations about these axes and motion/position along any of the DOF may be modifiable/controllable by interaction with a motion capture system as described herein.

Treadmill 600 provides rotation and translation by, for example, mounting a current design treadmill onto a gimbal mechanism that may actively control roll 610, pitch 620 and yaw 630 axes. Mating hemispheres and other well known gimbal mechanisms may be used to provide the required degrees-of-freedom (“DOF”). Belt 640 may be supported by rollers 650 which are attached to upper platform 660. Motor 670 connected with one of rollers 650 may be used to alter the speed of belt 640. Lower platform 680 is connected with upper platform 660 by a gimbal mechanism shown in FIG. 7. The gimbal mechanism includes multiple jackscrews 710 and motor 720 for controlling the roll, pitch and yaw axes. Jackscrews 710 and motor 720 may be controlled by controller 730. Also as described below TMF 690 may be applied to belt 640 to monitor footfall pressures or foot contact pressure distributions.

Using a motion capture system as described herein, treadmill 600 may move in 4 DOF (belt speed, roll, pitch and yaw) based upon a user's actual or anticipated position and/or based upon a virtual reality (“VR”) world simulation. The VR system may provide sensory association between said treadmill, said motion control system and a user of said treadmill. Sensory associations conveyed may include stress, pressure, shear, strain, light, heat, electromagnetic energy, RF radiation and temperature. Tracking and motion algorithms may use position and time derivative information (velocity, acceleration) from a user's body motion to actively control treadmill 600 so that the user's feet or other body parts always stay on belt 640. Although a treadmill is commonly used for walking/running/jogging, it should be understood that a user may be on their knees, hands, rolling, crawling, bear crawling, or performing other motions making different contact with treadmill 600.

Treadmill 600 may also move in response to the simulated environment. For example, if a user wearing VR goggles sees an image of terrain containing hills, the user will observe/feel the effects of traversing the simulated terrain as treadmill 600 changes pitch 620 to simulate terrain slope changes in the virtual terrain. The same applies to the perception of roll 610 as a user observes a simulated terrain of a hillside and treadmill 600 adjusts roll 610 similarly as the user walks laterally on a VR hillside. A user may also experience yaw 630 motion in a VR terrain as a user walks and/or runs to the side. In actual operation, an experience of yaw 630 motion may be better experienced while running since during a portion of the stride both feet of a user may lose contact with the belt. These VR motions may be controlled based upon the user's desired movement not solely based upon preset speeds or preprogrammed settings. Additionally or optionally, belt 640 may include TMF cells 690 to sense pressure data which may be used in conjunction with other motion data for control. The measured pressures related to the forces applied to belt 640 by a user and may be used to determine responses for changes to speed or direction by sensing changes in pressure between sides and/or ball/heel of a foot or rate of change of foot falls.

The changes described above, and others, may be made in the motion capture systems described herein without departing from the scope hereof. For example, although certain examples are described in association with a modified treadmill, it may be understood that the motion capture systems described herein may be adapted to other types of systems such as stationary cycles providing the point of view of a Tour de France cyclist. Furthermore, motion capture systems as described herein may include any number of simultaneous users and may themselves be permanently or temporarily used with any other system requiring motion capture.

It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A motion capture system comprising: at least four relatively positioned locating units defining an area; an RFID fiducial moving with a movable object within the vicinity of said defined area; said locating units receiving RF signals transmitted by said RFID fiducial; and a processing unit in communication with said locating units and said RFID fiducial, said processing unit transmitting RF signals to said RFID fiducial and receiving information from said locating units in response to said transmitted RF signals and determining a location of said RFID fiducial.

2. The motion capture system of claim 1, further including an interactive device using said location of said RFID fiducial to control a function of said device.

3. The motion capture system of claim 1, further including an interactive online system wherein said location of said RFID fiducial controls said interactive online system.

4. The motion capture system of claim 1, wherein said location of said RFID fiducial is used for at least one of an entertainment purpose, an officiating purpose and an archival purpose.

5. The motion capture system of claim 1, wherein a location determination method is used to determine said location of said RFID fiducial.

6. The motion capture system of claim 1, further comprising a plurality of RFID fiducials each associated with individualized cell codes.

7. The motion capture system of claim 1, wherein said RFID fiducial is formed with a portion of TMF.

8. The motion capture system of claim 7, wherein said RFID fiducial transmits sensory data within said RF signals.

9. The motion capture system of claim 6, wherein said RFID fiducials are sequentially scanned by said processing unit transmitting said individualized cell codes for each of said RFID fiducials.

10. The motion capture system of claim 9, wherein each of said sequentially scanned RFID fiducials are energized by said sequential scanning and conserve power by only transmitting RF signals when a corresponding transmitted individualized cell code is received.

11. The motion capture system of claim 1, further including means for energizing said RFID fiducials alternative to said RF signals transmitted from said processing unit.

12. The motion capture system of claim 1, further including a user of said motion capture system wherein said locating units and said processing unit are mobile with said user.

13. The motion capture system of claim 1, wherein calibration of said motion control system is performed by at least one of docking said locating units with said processing unit and contacting said RFID fiducial proximate to a reference point.

14. The motion control system of claim 1, wherein said motion control system is integrated with an audio/visual system.

15. An article for use with a motion capture system comprising an RFID fiducial and an article code; said article code identifying said article and an individual cell code for said RFID fiducial.

16. The article of claim 15, wherein said article is mobilized with a user; said user controlling an interactive device using said article.

17. The article of claim 15, wherein said RFID fiducial is formed with a portion of TMF and said RFID fiducial transmits RF signals encoding at least one of sensory data and location data.

18. A treadmill for use with a motion control system comprising: an upper platform connected with at least two rollers; at least one of said rollers driven by a motor; said rollers supporting and driving a belt; a gimbal assembly connecting said upper platform with a lower platform; said belt and said gimbal assembly responsive to said motion control system whereby modifying at least one of roll, pitch, yaw and belt speed.

19. The treadmill of claim 18, further including a virtual reality system providing sensory association between said treadmill, said motion control system and a user of said treadmill.

20. The treadmill of claim 18, further including a portion of TMF sensing user contact with said treadmill.
